(19) United States
(12) Patent Application Publication
(10) Pub. No.: US 2010/0280423 A1
(43) Pub. Date: Nov. 4, 2010

(54) MUSCLE FORCE ASSISTING DEVICE (AS AMENDED)

(75) Inventors: Takashi Kawakami, Ehime (JP); Toshihiko Ishiko, Ehime (JP); Keisuke Ueda, Osaka (JP)

Correspondence Address: RATNERPRESTIA, P.O. BOX 980, VALLEY FORGE, PA, 19482, US

(73) Assignee: Panasonic Corporation, Osaka (JP)

(21) Appl. No.: 12/810,596

(22) PCT Filed: Dec. 26, 2008
(86) PCT No.: PCT/JP2008/004014

§ 371 Date: Jun. 25, 2010

(30) Foreign Application Priority Data
Dec. 28, 2007 (JP) 2007 340673
Feb. 13, 2008 (JP) 2008 032347
Sep. 8, 2008 (JP) 2008 229364

(51) Int. Cl. A61H 1/02

(52) U.S. Cl. 601/33

(57) ABSTRACT

A muscle force assisting device includes a first attachment arranged along one bone of a joint, a second attachment arranged along the other bone of the joint, and an artificial muscle having one end provided on the first attachment and having the other end provided on the second attachment, in which an actuator is used as the artificial muscle, the muscle force assisting device assists motion of a user's joint such as an elbow, a knee and a wrist, the first attachment and the second attachment are connected to each other through spring joints, coil springs are used as the spring joints, the coil springs are deformed to moderate a deviation, smooth motion of the joint is secured, and even when a turning axis of the joint and rotation shafts of the attachments are deviated from each other, and the joint can smoothly bend and stretch.

### TECHNICAL FIELD

The present invention relates to a muscle force assisting device that assists motion of a user's joint such as an elbow, a knee, and a wrist using an actuator that is extensible by supplying or discharging a substance such as gas, liquid and solid, or a mixture thereof.

### BACKGROUND TECHNIQUE

There has already been proposed a power device including a tube that is characterized in that if a substance such as gas, liquid and solid, or a mixture thereof is infused into the tube, a size thereof in its longitudinal direction is restrained but it expands in its radial direction, a cylindrical sleeve that is extensible in its longitudinal direction and radial direction is disposed outside the tube, both ends of the tube are restrained, an inlet is formed in one of the ends, and a film or fiber made of polyester-based, polyamide-based, polyethylene-based, polyimide-based, polystyrene-based, polycarbonate-based substance or mixture thereof is used as the tube (patent document 1).

Further, a motion-assisting device utilizing this kind of power device is also proposed (patent documents 2 and 3).

According to the patent document 2, an elbow joint is bent and stretched by means of a joint tool made of elastic material, and the motion-assisting device assists the twisting motion in addition to the bending and stretching motion of the joint.

[Patent Document 1] Japanese Patent Application Laid-open No. 2004-105263

[Patent Document 2] PCT Application Laid-open No. 2007/043308

[Patent Document 3] Japanese Patent Application Laid-open No. 2007-167484

### DISCLOSURE OF THE INVENTION

However, the power device shown in the patent document 1 is attached to an elbow, since an attachment attached to an upper arm and an attachment attached to a forearm are connected to each other through one rotation shaft, a turning axis of the joint and the rotation shafts of the attachments are deviated from each other when the user wears or uses the power device, and the joint can not be bent or stretched sufficiently. In addition, an excessive load is put on a user.

In contrast, according to the motion-assisting device shown in the patent document 2, since the attachments are connected to each other through two shafts as a joint, it is possible to moderate the deviation between these shafts and the turning axis of the joint as compared with the one-shaft connecting configuration. Since this joint tool is made of elastic material, the joint tool flexibly follow the deviating motion of the shaft and the attachments. Therefore, even if a load such as the twisting motion is applied, it is possible to receive the load. However, to sufficiently endure repeated load for the long term, it is necessary to appropriately select the elastic material.

According to the double joint tools, since each joint ember is independent, there is a risk that the motion becomes unstable and the buckling of the joint tool occurs.

In the case of the double joint tools, when the buckling occurs, a positional relation between a first attachment and a second attachment is changed in a direction separating away from a joint of a user. This means, the attachment is deviated from an armor a leg of the user, and a wearing feeling is inferior, and if the power device is used for a long time, the attachment rubs against the user's body and this causes pain.

When the power device is attached to a wrist, since an attachment attached to a metacarpus and an attachment attached to a forearm are connected to each other through one rotation shaft, a turning axis of the joint and the rotation shafts of the attachments are deviated from each other like the case of the elbow, the joint can not be bent or stretched sufficiently, and an excessive load is put on a user in some cases. Further, a relative distance between the metacarpus and the forearm is changed by the bending or stretching motion but a distance between the attachments is not changed. This difference causes a deviation between the attachments and the forearm and the metacarpus of the user, and the wearing feeling is inferior, the attachment rubs against the user's body and this causes pain.

In contrast, in the case of the motion-assisting device, a deviation between the attachments and the turning axis of the joint is moderated by the joint tool, and a deviation between the attachments is also moderated. However, the distance between the attachments is determined, it is difficult to adjust the joint to an ideal position, the deviation of the shaft and the deviation of the attachments can not completely be solved.

The present invention has been accomplished to solve such a conventional problem, and it is an object of the invention to provide a muscle force assisting device capable of smoothly bend and stretch a joint even if a turning axis of the joint and rotation shafts of the attachments are deviated from each other, and capable of preventing an excessive load from being put on a user.

### MEANS FOR SOLVING THE PROBLEM

A first aspect of the present invention provides a muscle force assisting device comprising a first attachment arranged along one bone of a joint, and a second attachment arranged along the other bone of the joint, in which the muscle force assisting device assists motion of a user's joint such as an elbow, a knee and a wrist, the first attachment and the second attachment are connected to each other through a spring joint, and a coil spring is used as the spring joint.

According to a second aspect of the invention, the muscle force assisting device of the first aspect, further comprises an artificial muscle having one end provided on the first attachment and having the other end provided on the second attachment, and an actuator that is extensible by supplying or discharging a substance such as gas, liquid and solid, or a mixture thereof is used as the artificial muscle.

According to a third aspect of the invention, in the muscle force assisting device of the first aspect, the coil spring is used as an extension spring.

According to a fourth aspect of the invention, in the muscle force assisting device of the first aspect, when a phantom line passing through a turning axis of the joint and extending along a longitudinal direction of the first attachment is defined as an X-axis, and a phantom line passing through the turning axis of the joint and extending perpendicular to the X-axis is defined as a Y-axis, and when a bending direction of the second attachment with respect to an intersection between the X-axis and the Y-axis is defined as a plus direction of the Y-axis, in a state where the second attachment stretches with respect to the first attachment, an axis of the coil spring is located at a minus position of the Y-axis.

According to a fifth aspect of the invention, in the muscle force assisting device of the second aspect, the one end of the artificial muscle can be displaced with respect to the first attachment, the one end of the artificial muscle is displaced, thereby increasing a bending angle of the second attachment with respect to the first attachment as compared with a case where the one end of the artificial muscle is not displaced.

According to a sixth aspect of the invention, in the muscle force assisting device of the fifth aspect, the first attachment includes a swing arm, an end of the swing arm on a side opposite from the joint is a turning fulcrum, and an end of the swing arm on a side of the joint is a displacing end, and the one end of the artificial muscle is provided on the displacing end of the swing arm.

According to a seventh aspect of the invention, the muscle force assisting device of the first aspect further comprises a palm supporting member that supports a hand, an angle changing member connected to a side of the palm supporting member, a forearm attachment arranged along a forearm, and a joint member that displaces the angle changing member with respect to the forearm attachment, the palm supporting member and the angle changing member constitute the first attachment, and the forearm attachment constitutes the second attachment.

According to an eighth aspect of the invention, in the muscle force assisting device of the seventh aspect, the palm supporting member is a palm placing member that supports a back side of a hand.

According to a ninth aspect of the invention, in the muscle force assisting device of the seventh aspect, the palm supporting member is a palm grasping member that supports a palm side.

According to a tenth aspect of the invention, the muscle force assisting device of the seventh aspect further comprises one more angle changing member, the angle changing members are provided on both sides of the palm supporting member, the angle changing members have coil springs, respectively, and the coil springs are disposed on both sides of the wrist.

According to an eleventh aspect of the invention, in the muscle force assisting device of the tenth aspect, the coil springs are used as extension springs.

According to a twelfth aspect of the invention, in the muscle force assisting device of the tenth aspect, the coil springs are used as compression springs.

According to a thirteenth aspect of the invention, in the muscle force assisting device of the seventh aspect, the forearm attachment and the angle changing member are connected to each other through a straight driving actuator.

According to a fourteenth aspect of the invention, in the muscle force assisting device of the thirteenth aspect, an artificial muscle that is extensible by supplying or discharging a substance such as gas, liquid and solid, or a mixture thereof is used as the actuator.

According to a fifteenth aspect of the invention, in the muscle force assisting device of the tenth aspect, the forearm attachment and the angle changing member are connected to each other using two artificial muscles with respect to each angle changing member, and an actuator that is extensible by supplying or discharging a substance such as gas, liquid and solid, or a mixture thereof is used as the artificial muscle.

According to a sixteenth aspect of the invention, in the muscle force assisting device of the fifteenth aspect, an axis that connects fulcrums of the forearm attachment and the angle changing member on a non-driven artificial muscle of the two artificial muscles does not pass through inside of an arc formed by an axis of the coil spring.

According to a seventeenth aspect of the invention, the muscle force assisting device of the fifteenth aspect further comprises a first link member that is provided a turning fulcrum that is a palm side position of the angle changing member, and a second link member that is provided a turning fulcrum that is a back side position of the hand of the angle changing member, and the artificial muscles are connected to the other end of the first link member and the other end of the second link member, respectively.

According to an eighteenth aspect of the invention, in the muscle force assisting device of the seventeenth aspect, an axis that connects a fulcrum on the side of the forearm attachment and a turning fulcrum of the link member on the side of the angle changing member on a non-driven artificial muscle of the two artificial muscles does not pass through inside of an arc formed by an axis of the coil spring.

According to a nineteenth aspect of the invention, in the muscle force assisting device of the seventeenth aspect, the turning fulcrum of the first link member and the turning fulcrum of the second link member are disposed on a side closer to the forearm attachment than a position of the angle changing member where the coil spring is mounted, and a position in the vicinity of substantially a center of the coil spring in its longitudinal direction of its axis is a joint position of the wrist.

According to a twentieth aspect of the invention, the muscle force assisting device of the seventh aspect further comprises a moving mechanism that moves the palm supporting member toward or away from the forearm.

According to a twenty-first aspect of the invention, in the muscle force assisting device of the eighth aspect, a palm attachment is provided on an upper surface of the palm placing member, and a moving mechanism that moves the palm attachment toward or away from the forearm is provided.

According to a twenty-second aspect of the invention, in the muscle force assisting device of the ninth aspect, moving mechanisms that move the palm grasping member toward or away from the forearm, and turning axes that change an angle with respect to the moving mechanisms are provided on both ends of the palm grasping member, and the turning axes can be displaced with respect to the palm grasping member.

According to a twenty-third aspect of the invention, in the muscle force assisting device of the ninth aspect, a belt-fixing tool is provided on an upper surface or a lower surface of the palm grasping member.

According to a twenty-fourth aspect of the invention, in the muscle force assisting device of the ninth aspect, a palm placing member is provided on an upper surface or a lower surface of the palm grasping member.

### EFFECT OF THE INVENTION

According to the invention, the coil spring constitutes the spring joint. With this configuration, even if the muscle force assisting device and a joint are deviated from each other, smooth movement of the joint of the user can be secured.

### BRIEF DESCRIPTION OF THE DRAWINGS

FIG. 1 is a diagram of a configuration showing a stretched state of an elbow assisting device according to an embodiment of the present invention;

FIG. 2 is a diagram of a configuration showing a state where the device is being bent;

FIG. 3 is a diagram of a configuration showing a bent state of the device;

FIG. 4 is a perspective view of essential portions of the device shown in FIG. 1;

FIG. 5 is a perspective view of essential portions of the device shown in FIG. 3;

FIG. 6 is a side view of a wrist assisting device according to an embodiment of the invention;

FIG. 7 is a perspective view of the device shown in FIG. 6;

FIG. 8 is a bottom view of the device shown in FIG. 6;

FIG. 9 is a diagram of a basic configuration showing operation of the device;

FIG. 10 is a diagram of a configuration showing a bending state of the device toward a palm side;

FIG. 11 is a diagram of a configuration showing a bending state of the device toward a back side of a hand;

FIG. 12 is a perspective view of a wrist assisting device according to another embodiment of the invention;

FIG. 13 is a diagram of a configuration showing a bending state of the device toward the palm side;

FIG. 14 is a diagram of a configuration showing a bending state of the device toward the back side of the hand;

FIG. 15 is a diagram showing a relation between an axis A connecting a fulcrum of a non-driven side artificial muscle on the side of a forearm attachment of the device and a turning fulcrum of a link member with each other, and an arc B formed by an axis of a coil spring;

FIG. 16 is a perspective view of a wrist assisting device according to another embodiment of the invention as viewed from above;

FIG. 17 is a perspective view of the device shown in FIG. 16 as viewed from below;

FIG. 18 is a side view of the device shown in FIG. 16;

FIG. 19 is a plan view of the device shown in FIG. 16;

FIG. 20 is a plan view showing a first using state of the device;

FIG. 21 is a side view showing palm-bending state in the first using state of the device;

FIG. 22 is a side view showing a back-bending state in the first using state of the device;

FIG. 23 is a side view showing a second using state of the device;

FIG. 24 is a side view showing a back-bending state in the second using state of the device; and

FIG. 25 is a side view showing a palm-bending state in the second using state of the device.

### BEST MODE FOR CARRYING OUT THE INVENTION

According to a muscle force assisting device of a first aspect of the present invention, a first attachment and a second attachment are connected to each other through spring joints, and coil springs are used as the spring joints. According to the embodiment, even if the muscle force assisting device and the joint are deviated from each other, the deviation can be moderated by deformation of the coil springs. Therefore, smooth motion of the joint can be secured. With this aspect, even if the muscle force assisting device and the joint are deviated from each other, the deviation can be moderated by the deformation of the coil springs. Therefore, the joint can smoothly move.

According to the second aspect of the invention, the muscle force assisting device of the first aspect, further comprises an artificial muscle having one end provided on the first attachment and having the other end provided on the second attachment, and an actuator that is extensible by supplying or discharging a substance such as gas, liquid and solid, or a mixture thereof is used as the artificial muscle. With this aspect, it is possible to bring the motion of the muscle force assisting device close to motion of muscle of a human body.

According to the third aspect of the invention, in the muscle force assisting device of the first aspect, the coil spring is used as an extension spring. With this aspect, constrained crimping between the coils can be prevented, the coils are not sandwiched therebetween and therefore, smooth motion can be carried out.

According to the fourth aspect of the invention, in the muscle force assisting device of the first aspect, when a phantom line passing through a turning axis of the joint and extending along a longitudinal direction of the first attachment is defined as an X-axis, and a phantom line passing through the turning axis of the joint and extending perpendicular to the X-axis is defined as a Y-axis, and when a bending direction of the second attachment with respect to an intersection between the X-axis and the Y-axis is defined as a plus direction of the Y-axis, in a state where the second attachment stretches with respect to the first attachment, an axis of the coil spring is located at a minus position of the Y-axis. With this aspect, since the displacing structures of the turning axis of the joint and the rotation shaft of the coil spring are similar to each other at the time of bending motion, a deviation between the muscle force assisting device and the joint can be reduced. Further, since angles formed by the first attachment and the second attachment with respect to the spring joint are equal to each other, loads applied to the first attachment and second attachment become equal to each other. Therefore, the motion of the coil spring is smoothened, and endurance of the coil spring against repeated loads can be enhanced.

According to the fifth aspect of the invention, in the muscle force assisting device of the second aspect, the one end of the artificial muscle can be displaced with respect to the first attachment, the one end of the artificial muscle is displaced, thereby increasing a bending angle of the second attachment with respect to the first attachment as compared with a case where the one end of the artificial muscle is not displaced. With this aspect, it is possible to increase the bending angle without increasing the bending torque.

According to the sixth aspect of the invention, in the muscle force assisting device of the fifth aspect, the first attachment includes a swing arm, an end of the swing arm on a side opposite from the joint is a turning fulcrum, and an end of the swing arm on a side of the joint is a displacing end, and the one end of the artificial muscle is provided on the displacing end of the swing arm. With this aspect, it is possible to change the position of the one end of the artificial muscle.

According to a seventh aspect of the invention, the muscle force assisting device of the first aspect further comprises a palm supporting member that supports a hand, an angle changing member connected to a side of the palm supporting member, a forearm attachment arranged along a forearm, and a joint member that displaces the angle changing member with respect to the forearm attachment, the palm supporting member and the angle changing member constitute the first attachment, and the forearm attachment constitutes the second attachment. With this aspect, smooth motion of the wrist can be secured.

According to an eighth aspect of the invention, in the muscle force assisting device of the seventh aspect, the palm supporting member is a palm placing member that supports a back side of a hand. With this aspect, palm-bending motion and back-bending motion can be carried out without hindering the palm motion.

According to a ninth aspect of the invention, in the muscle force assisting device of the seventh aspect, the palm supporting member is a palm grasping member that supports a palm side. With this aspect, play at the time of the back-bending motion can be reduced and the back-bending region can sufficiently be secured as compared with a case where the palm placing member is used.

According to a tenth aspect of the invention, the muscle force assisting device of the seventh aspect further comprises one more angle changing member, the angle changing members are provided on both sides of the palm supporting member, the angle changing members have coil springs, respectively, and the coil springs are disposed on both sides of the wrist. With this aspect, since the pair of coil springs support the both sides of the wrist, the wrist can smoothly move, and the wrist can strongly be held.

According to an eleventh aspect of the invention, in the muscle force assisting device of the tenth aspect, the coil springs are used as extension springs. With this aspect, resistance at the time of the palm-bending or back-bending motion of the wrist is reduced, and smooth motion can be carried out.

According to a twelfth aspect of the invention, in the muscle force assisting device of the tenth aspect, the coil springs are used as compression springs. With this aspect, the length of the spring becomes constant at the axis of the spring with respect to the palm-bending or back-bending motion of the wrist. Therefore, if the axis is disposed on the axis of the wrist joint, the influence of deviation can be suppressed to a low value with respect to bending motion in any direction, and smooth motion can be carried out. Further, since there is no contact between the coils, degeneration or alteration caused by a rub between the coils can be suppressed even if the device is repeatedly used for a long term.

According to a thirteenth aspect of the invention, in the muscle force assisting device of the seventh aspect, the forearm attachment and the angle changing member are connected to each other through a straight driving actuator. With this aspect, even if the straight driving actuator is used, it is possible to assist the wrist motion.

According to a fourteenth aspect of the invention, in the muscle force assisting device of the thirteenth aspect, an artificial muscle that is extensible by supplying or discharging a substance such as gas, liquid and solid, or a mixture thereof is used as the actuator. With this aspect, it is possible to bring the motion of the muscle force assisting device to the motion of muscle of human body, and rehabilitation effect is enhanced.

According to the fifteenth aspect of the invention, in the muscle force assisting device of the tenth aspect, the forearm attachment and the angle changing member are connected to each other using two artificial muscles with respect to each angle changing member, and an actuator that is extensible by supplying or discharging a substance such as gas, liquid and solid, or a mixture thereof is used as the artificial muscle. With this aspect, the wrist can bend toward both the palm side and back side of the hand.

According to the sixteenth aspect of the invention, in the muscle force assisting device of the fifteenth aspect, an axis that connects fulcrums of the forearm attachment and the angle changing member on a non-driven artificial muscle of the two artificial muscles does not pass through inside of an arc formed by an axis of the coil spring. With this aspect, the wrist can smoothly bend from the palm side to the back side or from the back side to the palm side.

According to the seventeenth aspect of the invention, the muscle force assisting device of the fifteenth aspect further comprises a first link member that is provided a turning fulcrum that is a palm side position of the angle changing member, and a second link member that is provided a turning fulcrum that is a back side position of the hand of the angle changing member, and the artificial muscles are connected to the other end of the first link member and the other end of the second link member, respectively. With this aspect, the wrist can bend toward both the palm side and back side of the hand. A sag of the artificial muscle in the initial state can be prevented. After the wrist is bent or stretched in one direction, bracing when bending or stretching motion is carried out in the opposite direction can be prevented, and large displacement can be obtained with small strinkage of the artificial muscle.

According to an eighteenth aspect of the invention, in the muscle force assisting device of the seventeenth aspect, an axis that connects a fulcrum on the side of the forearm attachment and a turning fulcrum of the link member on the side of the angle changing member on a non-driven artificial muscle of the two artificial muscles does not pass through inside of an arc formed by an axis of the coil spring. With this aspect, the wrist can smoothly bend from palm side to the back side or from the back side to the palm side.

According to a nineteenth aspect of the invention, in the muscle force assisting device of the seventeenth aspect, the turning fulcrum of the first link member and the turning fulcrum of the second link member are disposed on a side closer to the forearm attachment than a position of the angle changing member where the coil spring is mounted, and a position in the vicinity of substantially a center of the coil spring in its longitudinal direction of its axis is a joint position of the wrist. With this aspect, the position of the wrist joint and the position of the joint member of the muscle force assisting device can match with each other, and smooth motion can be realized.

According to a twentieth aspect of the invention, the muscle force assisting device of the seventh aspect further comprises a moving mechanism that moves the palm supporting member toward or away from the forearm. With this aspect, it is possible to eliminate such uncomfortable feeling that a hand is pushed toward the forearm or pulled in a direction separating away from the forearm.

According to a twenty-first aspect of the invention, in the muscle force assisting device of the eighth aspect, a palm attachment is provided on an upper surface of the palm placing member, and a moving mechanism that moves the palm attachment toward or away from the forearm is provided. With this aspect, it is possible to eliminate such uncomfortable feeling that a hand is pushed toward the forearm or pulled in a direction separating away from the forearm.

According to a twenty-second aspect of the invention, in the muscle force assisting device of the ninth aspect, moving mechanisms that move the palm grasping member toward or away from the forearm, and turning axes that change an angle with respect to the moving mechanisms are provided on both ends of the palm grasping member, and the turning axes can be displaced with respect to the palm grasping member. With this aspect, since the angle of the palm grasping member is changed, it is easy to grasp the palm grasping member, and even when the wrist is crooked, the wrist assisting device can be used appropriately.

According to a twenty-third aspect of the invention, in the muscle force assisting device of the ninth aspect, a belt-fixing tool is provided on an upper surface or a lower surface of the palm grasping member. With this aspect, even when grasping power is weakened, the wrist can be supported by a belt.

According to a twenty-fourth aspect of the invention, in the muscle force assisting device of the ninth aspect, a palm placing member is provided on an upper surface or a lower surface of the palm grasping member. With this aspect, even when grasping power is weakened, the wrist can be supported from the back side of the hand.

### EMBODIMENTS

Embodiments of the present invention will be described below based on the drawings.

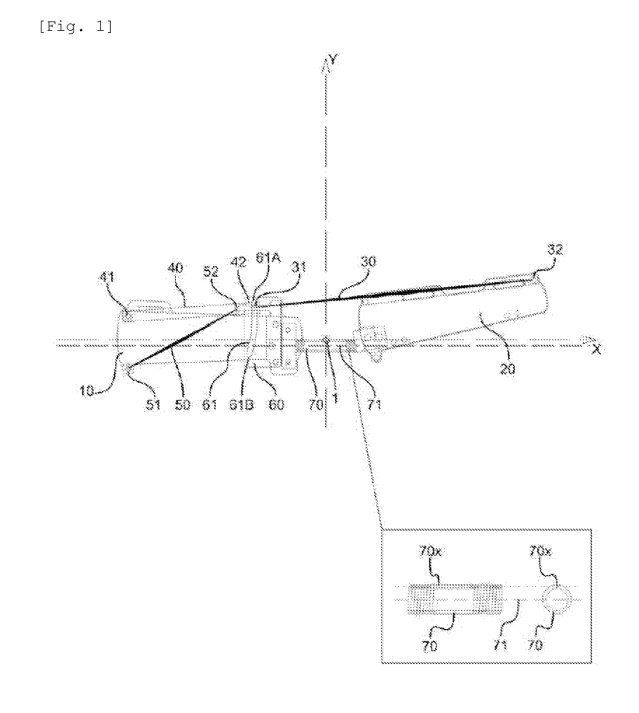

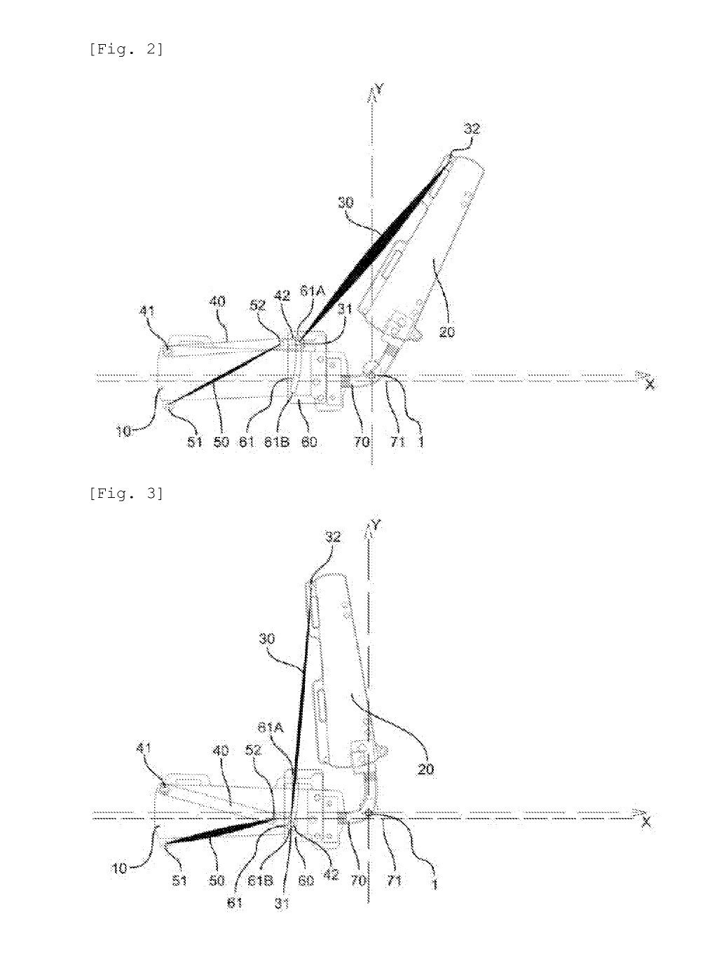

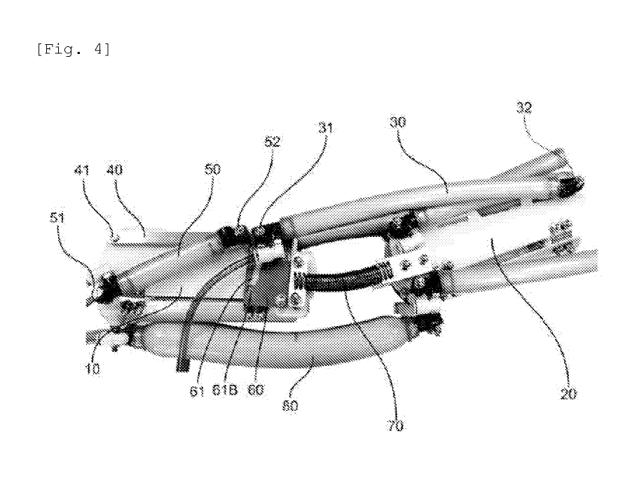

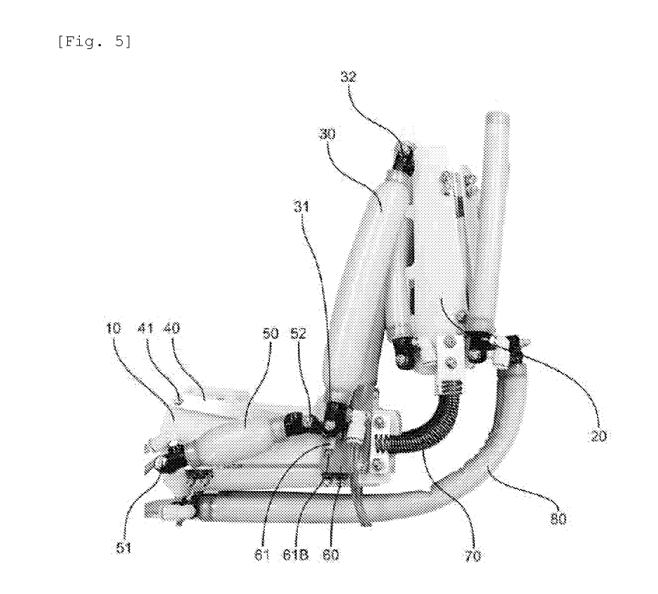

FIG. 1 is a diagram of a configuration showing a stretched state of an elbow assisting device according to an embodiment of the present invention. FIG. 2 is a diagram of a configuration showing a state where the device is being bent. FIG. 3 is a diagram of a configuration showing a bent state of the device. FIG. 4 is a perspective view of essential portions of the device shown in FIG. 1. FIG. 5 is a perspective view of essential portions of the device shown in FIG. 3.

The elbow assisting device of the embodiment includes a first attachment 10 arranged along one bone of a joint, a second attachment 20 arranged along the other bone of the joint, and an artificial muscle 30 having one end 31 provided on the first attachment 10 and having the other end 32 provided on the second attachment 20.

When the elbow assisting device is attached to an elbow as in this embodiment, the first attachment 10 is attached to an upper arm, and the second attachment 20 is attached to a forearm.

The artificial muscle 30 is an actuator that is extensible at least in its longitudinal direction by supplying or discharging a substance such as gas, liquid and solid, or a mixture thereof.

The first attachment 10 has a swing arm 40. An end of the swing arm 40 on a side opposite from the joint is a turning fulcrum 41, and an end of the swing arm 40 on the side of the joint is a displacing end 42. The one end 31 of the artificial muscle 30 is provided on the displacing end 42 of the swing arm 40.

The first attachment 10 includes an auxiliary artificial muscle 50. One end 51 of the auxiliary artificial muscle 50 is provided on an end of the first attachment 10 opposite from the joint, and the other end 52 is provided on the displacing end 42 of the swing arm 40.

The first attachment 10 includes a guide plate 60. The guide plate 60 has a guide hole 61, and the displacing end 42 of the swing arm 40 is displaced along the guide hole 61.

In the following description of the elbow assisting device, a phantom line passing through a turning axis 1 of the joint and extending along a longitudinal direction of the first attachment 10 is defined as an X-axis, and a phantom line passing through the turning axis 1 of the joint and extending perpendicular to the X-axis is defined as a Y-axis. A bending direction of the second attachment 20 with respect to an intersection (turning axis 1) between the X-axis and the Y-axis is defined as a plus direction of the Y-axis.

The turning axis 1 shows a position of the joint in a state where the second attachment 20 stretches to the utmost with respect to the first attachment 10. In the bent state shown in FIGS. 2 and 3, the turning axis 1 is displaced within a circle shown with dotted lines.

The turning fulcrum 41 of the swing arm 40 is disposed at the plus position of the Y-axis, and the one end 51 of the auxiliary artificial muscle 50 is disposed at a minus position of the Y-axis. One end 61A of the guide hole 61 is disposed at the plus position of the Y-axis, and the other end 61B of the guide hole 61 is disposed at the minus position of the Y-axis.

The first attachment 10 and the second attachment 20 are connected to each other through spring joints 70. Coil springs are used as the spring joints 70, and extension springs are used as the coil springs. Each of the spring joints 70 is disposed such that an axis 71 of the coil spring is located at the minus position of the Y-axis in a state where the second attachment 20 stretches to the utmost with respect to the first attachment 10. In addition, a length of each of the coil springs is adjusted such that a deviation of a rotation shaft of the coil spring becomes equal to a deviation of a turning axis of the joint.

The muscle force assisting device includes a first power source (not shown) that contracts the artificial muscle 30, and a second power source (not shown) that contracts the auxiliary artificial muscle 50. It is preferable that the artificial muscle 30 and the auxiliary artificial muscle 50 are provided on each of both sides of each arm in a pair.

As shown in FIGS. 4 and 5, a stretching-artificial muscle 80 is provided on the side of the elbow. FIG. 4 shows a state where the stretching-artificial muscle 80 is contracted to the utmost, and FIG. 5 shows a state where the stretching-artificial muscle 80 stretches to the utmost.

Operation of the elbow assisting device of the embodiment will be described below.

As shown in FIG. 1, in the stretched state of the elbow assisting device, the second attachment 20 has a constant angle with respect to the first attachment 10. For example, an end of the second attachment 20 on a side opposite from the joint has an initial angle of about 10° in the plus direction of the Y-axis. In this state, the artificial muscle 30 and the auxiliary artificial muscle 50 stretch to the utmost in the longitudinal direction.

The displacing end 42 of the swing arm 40 is disposed on the one end 61A of the guide hole 61.

An axis 71 of the coil spring is disposed at the minus position of the Y-axis. A center line 70y (not shown) of the coil spring in its longitudinal direction is superposed on the Y-axis. A center 70x of the upper winding of the coil spring in the longitudinal direction is disposed substantially at the minus position of the Y-axis.

FIG. 2 is a halfway state of the bending motion where oly the artificial muscle 30 is operated by the first driving source in the stretched state shown in FIG. 1.

Since operation of the second driving source is not carried out, the auxiliary artificial muscle 50 maintains a state where it stretches to the utmost in the longitudinal direction. At that time, the displacing end 42 of the swing arm 40 remains in a state where the displacing end 42 is disposed on the one end 61A of the guide hole 61.

Therefore, by operating only the artificial muscle 30 by the first driving source, the artificial muscle 30 contracts in its longitudinal direction, and the second attachment 20 bends only slightly with respect to the first attachment 10 by the contraction of the artificial muscle 30.

FIG. 3 shows a bent state where the auxiliary artificial muscle 50 is operated by the second driving source in the halfway state of the bending motion shown in FIG. 2.

By operating the auxiliary artificial muscle 50 by the second driving source, the auxiliary artificial muscle 50 contracts in the longitudinal direction, and the displacing end 42 of the swing arm 40 moves to the other end 61B of the guide hole 61 by the contraction of the auxiliary artificial muscle 50.

If the displacing end 42 moves to the other end 61B, the one end 31 of the artificial muscle 30 also moves to the other end 61B of the guide hole 61, and the second attachment 20 further largely bends with respect to the first attachment 10.

In a state where the second attachment 20 stretches with respect to the first attachment 10 as in this embodiment, the axis 71 of the coil spring is disposed at the minus position of the Y-axis. The center line 70y of the coil spring in the longitudinal direction is disposed on the Y-axis, and the center 70x of the upper winding of the coil spring in the longitudinal direction is disposed substantially at the minus position of the Y-axis. With this layout, since displacing structures of the turning axis 1 of the joint and the rotation shafts of the coil springs are similar to each other, it is possible to reduce the deviation between the elbow assisting device and the joint.

Since angles formed between the coil springs of the first attachment and the second attachment are equal to each other, loads applied to the first attachment and the second attachment are equal to each other. With the equal loads, the coil spring form the largest arc. Therefore, the motion of the coil spring is smoothened, and endurance of the coil spring against repeated loads can be enhanced.

In the description of the operation of the embodiment, the auxiliary artificial muscle 50 is operated after the operation of the artificial muscle 30 is completed. However, at the time of the bending operation, the operation of the first power source may be started before the operation of the second power source is started, and the operation of the auxiliary artificial muscle 50 may be started before the operation of the artificial muscle 30 is completed.

In the elbow assisting device of the embodiment, the first attachment 10 and the second attachment 20 are connected to each other through the spring joints 70, and the coil springs are used as the spring joints 70. Therefore, even if the elbow assisting device and the joint are deviated from each other, the coil springs are deformed to moderate the deviation, and smooth motion of the elbow can be secured.

The elbow assisting device of the embodiment includes the artificial muscle 30 having one end 31 provided on the first attachment 10 and having the other end 32 provided on the second attachment 20, and the actuator that is extensible by supplying or discharging a substance such as gas, liquid and solid, or a mixture thereof is used as the artificial muscle 30. Therefore, the elbow assisting device can carry out motion that is closer to a muscle of a human body. Further, rehabilitation effect is enhanced.

According to the elbow assisting device of the embodiment, a phantom line passing through the turning axis 1 of the joint and extending along the longitudinal direction of the first attachment 10 is defined as an X-axis, a phantom line passing through the turning axis 1 of the joint and extending perpendicular to the X-axis is defined as a Y-axis, and a bending direction of the second attachment 20 with respect to an intersection between the X-axis and the Y-axis is defined as a plus direction of the Y-axis. In a state where the second attachment 20 stretches with respect to the first attachment 10, the axis of the coil spring is located at the minus position of the Y-axis. Therefore, it is possible to reduce a deviation between the elbow assisting device and the joint at the time of bending motion. The motion of the coil spring can be smoothened, and endurance thereof against repeated loads can be enhanced.

In the elbow assisting device of the embodiment, the coil springs are used as extension springs. Therefore, constrained crimping between the coils can be prevented, the coils are not sandwiched therebetween and therefore, smooth motion can be carried out.

According to the elbow assisting device of the embodiment, the one end 31 of the artificial muscle 30 can be displaced with respect to the first attachment 10, and the bending angle of the second attachment 20 with respect to the first attachment 10 is increased by displacing the one end 31 of the artificial muscle 30 as compared with a case where the one end 31 of the artificial muscle 30 is not displaced. Therefore, it is possible to increase the bending angle without increasing a bending torque by displacing the one end 31 of the artificial muscle 30.

According to the elbow assisting device of the embodiment, the first attachment 10 includes the swing arm 40, the end of the swing arm 40 on the side opposite from the joint is the turning fulcrum 41, and the end of the swing arm 40 on the side of the joint is the displacing end 42, and the one end 31 of the artificial muscle 30 is provided on the displacing end 42 of the swing arm 40. Therefore, the position of the one end 31 of the artificial muscle 30 can be changed by providing the one end 31 of the artificial muscle 30 on the displacing end 42 of the swing arm 40.

An embodiment of the wrist assisting device of the present invention will be described below.

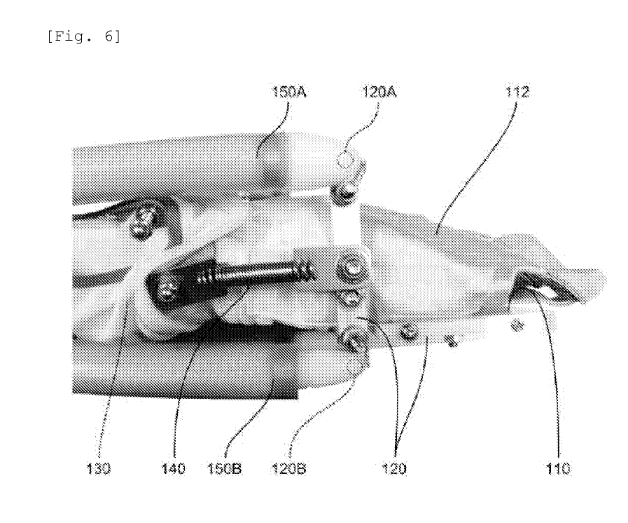

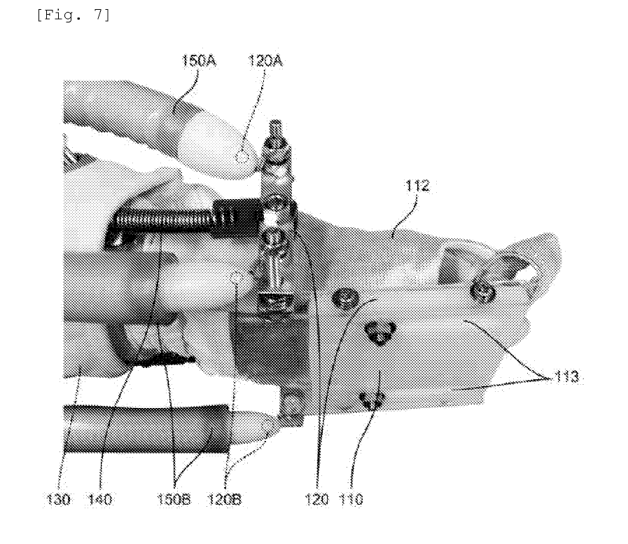

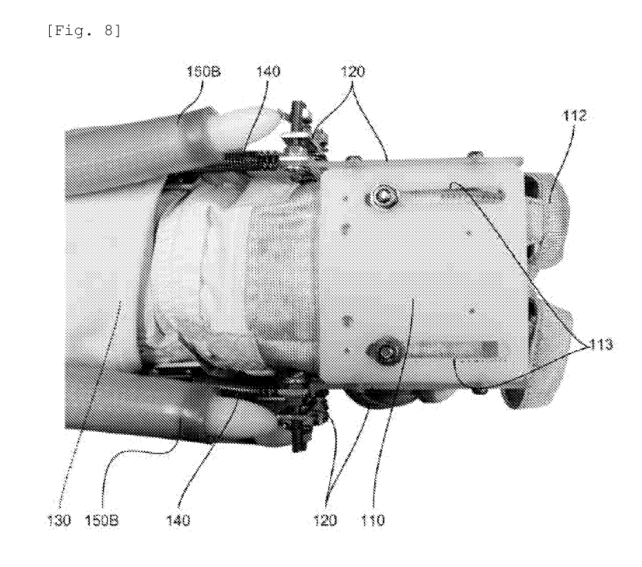

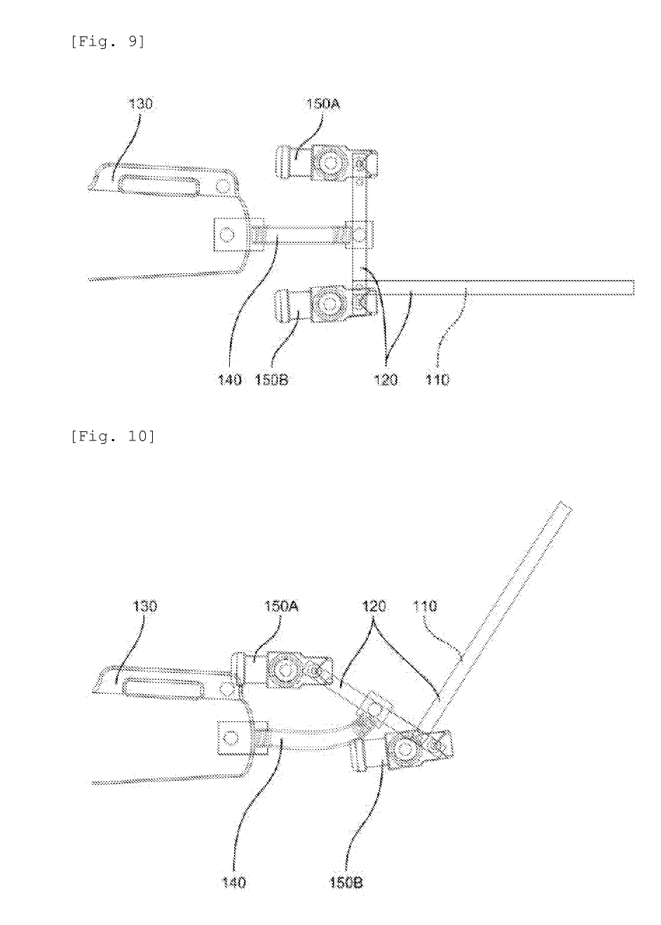

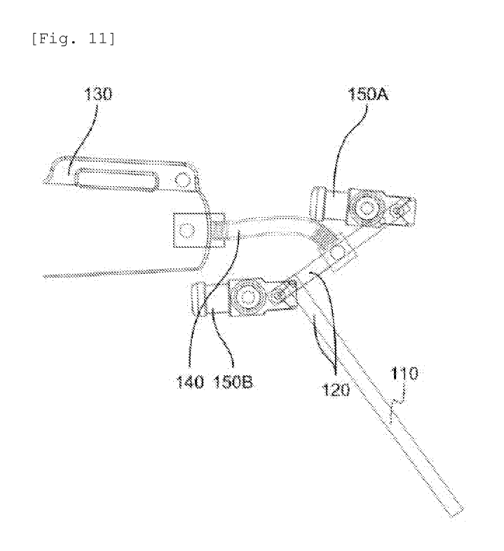

FIG. 6 is a side view of the wrist assisting device according to the embodiment. FIG. 7 is a perspective view of the device shown in FIG. 6. FIG. 8 is a bottom view of the device shown in FIG. 6. FIG. 9 is a diagram of a basic configuration showing operation of the device. FIG. 10 is a diagram of a configuration showing a bending state of the device toward a palm side. FIG. 11 is a diagram of a configuration showing a bending state of the device toward a back side of a hand.

The wrist assisting device of the embodiment includes a palm placing member (palm supporting member) 110 that supports a back side of a hand, angle changing members 120 that are connected to sides of the palm placing member 110, a forearm attachment 130 disposed along the forearm, and joint members 140 that displace the angle changing members 120 with respect to the forearm attachment 130.

Coil springs are used as the joint members 140. In the wrist assisting device of the embodiment, extension springs are used as the joint members 140. With this configuration, a driving force generated by an actuator provided astride the wrist joint and a contraction force generated by the driving force in an axial direction for compressing the wrist joint can antagonize against each other. Therefore, it is possible to reduce the inhibition against a force (torque) for palm-bending and back-bending of the wrist joint. That is, a resistance of the wrist assisting device to the wrist is small, and smooth motion can be carried out.

In the wrist assisting device of the embodiment, compression springs are used as the joint members 140. With this configuration, a length of the spring at the axis of the spring becomes constant with respect to the palm-bending and back-bending motion of the wrist. Further, since the axis of the spring is located on an axis of the wrist joint, it is possible to reduce influence of a deviation between the wrist assisting device and the joint irrespective of the bending direction. Therefore, smooth motion can be carried out. Further, since there is no contact between the coils, degeneration or alteration caused by a rub between the coils can be suppressed.

The angle changing members 120 are a pair of substantially L-shaped members, and they are provided on both sides of the palm placing member 110. The joint members 140 are provided for the angle changing members 120, respectively. The joint members 140 are located on both sides of the wrist.

The forearm attachment 130 and the angle changing members 120 are connected to each other through artificial muscles 150. As shown in the drawings, the forearm attachment 130 and the angle changing member 120 are connected to each other using two artificial muscles 150A and 150B for each angle changing member 120. That is, the artificial muscle 150A is connected to a palm side position 120A of the angle changing member 120, and the other artificial muscle 150B is connected to a back side position 120B of the hand of the angle changing member 120.

The artificial muscle 150 is an actuator that is extensible at least in its longitudinal direction by supplying or discharging a substance such as gas, liquid and solid, or a mixture thereof. Another mechanism may be used as the actuator only if it straightly drives the forearm attachment 130 and the angle changing members 120.

According to the wrist assisting device of the embodiment, the forearm attachment 130 and the angle changing member 120 are connected to each other using the two artificial muscles 150 for each angle changing member 120, and the actuator that is extensible by supplying or discharging a substance such as gas, liquid and solid, or a mixture thereof is used as the artificial muscle 150. Therefore, it is possible to bend the wrist toward both the palm side and the back side of the hand.

A palm attachment 112 having a plate (not shown) therein is provided on an upper surface of the palm placing member 110. The palm attachment 112 holds the hand. A moving mechanism (not shown) that moves the palm attachment 112 toward or away from the forearm is provided between the palm attachment 112 and the palm placing member 110 having a guide groove 113.

By providing the moving mechanism that moves the palm attachment 112 toward or away from the forearm with respect to the palm placing member 110, it is possible to eliminate such uncomfortable feeling that a hand is pushed toward the forearm or pulled in a direction separating away from the forearm. A deviation that can not be adjusted due to a reason of design is absorbed, and tolerance of difference of a physical type is increased. Therefore, fine adjustment on an individual basis becomes unnecessary.

The palm attachment 112 may be fixed to the palm placing member 110, and a moving mechanism that moves the palm attachment 112 fixed to the palm placing member 110 toward or away from the forearm may be provided between the palm placing member 110 and the angle changing member 120. The palm attachment 112 has a configuration like a glove for wrapping at least a metacarpus for example.

The wrist assisting device includes an adjusting mechanism that adjusts lengths of coil springs that are the joint members 140 such that a deviation between the rotation shafts of the joint members 140 becomes equal to a deviation of the joint. When each of the joint members 140 is disposed, it is preferable that a portion of the joint member 140 corresponding an inside of bending motion of the spring is located on or near the axis of the joint when the joint member 140 is the extension spring, and the axis of the spring is located on or near the axis of the joint when the joint member 140 is the compression spring.

The wrist assisting device includes a palm side (not shown) that contracts the artificial muscle 150. It is preferable that the artificial muscles 50 are provided on each of both sides of each arm in a pair.

Operation of the wrist assisting device of the embodiment will be described below.

In a state shown in FIG. 9, the palm is kept horizontally. If the one artificial muscle 150A is contracted from the state shown in FIG. 9, the angle changing members 120 is displaced with respect to the forearm attachment 130 as shown in FIG. 10. By displacing the angle changing member 120, the palm placing member 110 can be bent toward the palm side (i.e., palm-bending) together with the angle changing member 120.

If the other artificial muscle 150B is contracted from the state shown in FIG. 9, the angle changing member 120 is displaced with respect to the forearm attachment 130 as shown in FIG. 11. With this displacement, the palm placing member 110 can be bent toward the back side (i.e., back-bending) of the hand together with the angle changing member 120.

As described above, the wrist assisting device of the embodiment includes the palm placing member (palm supporting member) 110 that supports the hand, the angle changing members 120 connected to sides of the palm placing member 110, the forearm attachment 130 disposed along the forearm, and the joint members 140 that displace the angle changing members 120 with respect to the forearm attachment 130. The palm placing member 110 and the angle changing members 120 constitute a first attachment, and the forearm attachment 130 constitutes a second attachment. The first attachment and the second attachment are connected to each other through the joint members 140, and coil springs are used as the joint members 140. According to this configuration, even if the wrist assisting device and the joint are deviated from each other in position, the coil springs are deformed to moderate the deviation, and smooth motion of the wrist can be secured.

According to the wrist assisting device of the embodiment, the palm supporting member is the palm placing member 110 that supports the back side of the hand. Therefore, palm-bending and back-bending can be carried out without hindering the motion of the palm.

According to the wrist assisting device of the embodiment, the angle changing members 120 are provided on both sides of the palm placing member 110, the joint members 140 are respectively provided on the angle changing members 120, and the joint members 140 are located on both sides of the wrist. Therefore, since the both sides of the wrist are supported by the pair of coil springs, the wrist can move smoothly, and the wrist can be held strongly.

According to the wrist assisting device of the embodiment, the forearm attachment 130 and the angle changing members 120 are connected to each other through the straightly driving actuators. Therefore the wrist motion can be assisted using the straightly driving actuators also.

The wrist assisting device of the embodiment uses the artificial muscle as the actuator that is extensible by supplying or discharging a substance such as gas, liquid and solid, or a mixture thereof. Therefore, the wrist assisting device can carry out motion that is closer to a muscle of a human body, and rehabilitation effect can be enhanced.

Next, another embodiment of the muscle force assisting device of the invention will be described.

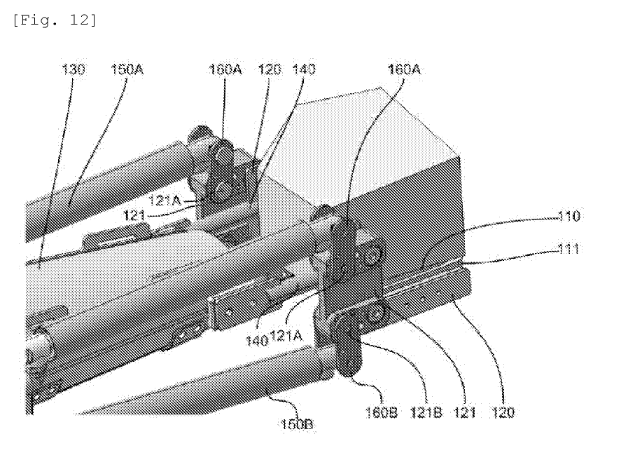

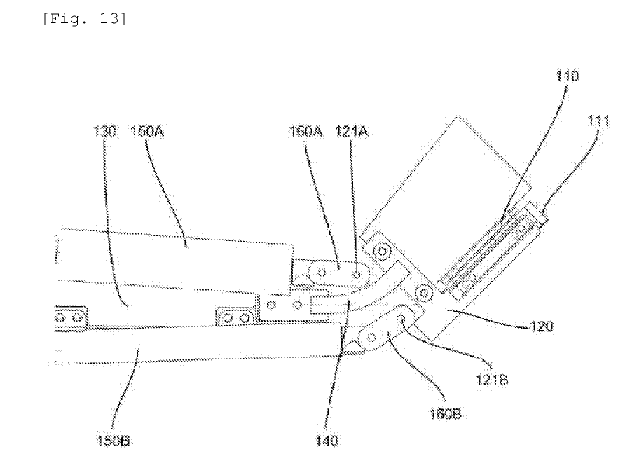

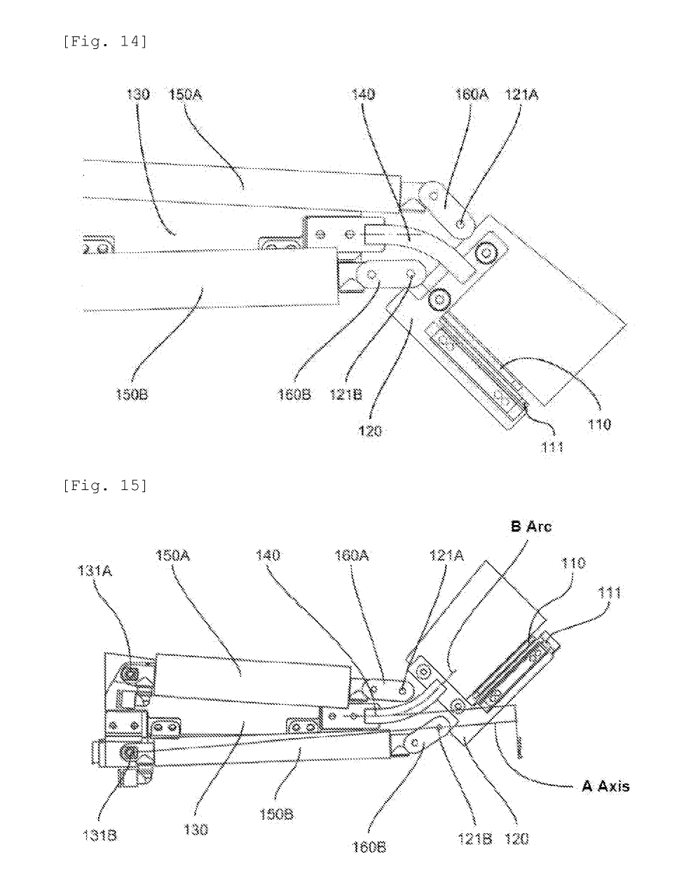

FIG. 12 is a perspective view of a wrist assisting device according to this embodiment. FIG. 13 is a diagram of a configuration showing a bending state of the device toward the palm side. FIG. 14 is a diagram of a configuration showing a bending state of the device toward the back side of the hand. FIG. 15 is a diagram showing a relation between an axis A connecting a fulcrum of a non-driven side artificial muscle on the side of a forearm attachment of the device and a turning fulcrum of a link member with each other, and an arc B formed by an axis of a coil spring. The same members as those of the above embodiment are designated with the same symbols, and explanation thereof will be omitted.

According to the wrist assisting device of the embodiment, connection members 121 are connected to the angle changing members 120, one ends of first link members 160A and second link members 160B are turnably mounted on the connection members 121.

That is, the wrist assisting device of the embodiment includes the first link members 160A that are provided turning fulcrums that are the palm side positions 121A of the angle changing members 120, and includes second link members 160B that are provided turning fulcrums that are the back side positions 121B of the hand of the angle changing members 120. The artificial muscle 150A is turnably connected to the other end of each of the first link members 160A, and the artificial muscle 150B is turnably connected to the other end of each of the second link members 160B. According to this embodiment, the wrist can smoothly bend both the palm side and the back side. After the artificial muscle bends or stretches in one direction, projecting motion when the artificial muscle bends or stretches in the opposite direction that prevents a sag of the artificial muscle in its initial state is prevented. Therefore, the artificial muscle can largely be displaced with a small shrinkage.

According to the wrist assisting device of the embodiment, the palm side positions 121A that are turning fulcrums of the first link members 160A and the back side positions 121B that are turning fulcrums of the second link members 160B are disposed closer to the forearm attachment 130 than the coil spring mounting positions (for mounting the joint members 140) of the angle changing members 120. A position in the vicinity of substantially the center of the axis of the coil spring that is the joint member 140 in its longitudinal direction is the joint position of the wrist.

According to the embodiment, the angle of the artificial muscle can largely be changed with small displacement (shrinkage) of the artificial muscle, and the position of the joint of the wrist and the position of the joint member of the wrist assisting device can match with each other. Therefore, a wrist that wears the wrist assisting device can smoothly move.

According to the wrist assisting device of the embodiment, the forearm attachment 130 and the angle changing member 120 are connected to each other using two artificial muscles 150A and 150B for one angle changing member 120, and the actuator that is extensible by supplying or discharging a substance such as gas, liquid and solid, or a mixture thereof is used as each of the artificial muscles 150A and 150B. Therefore, the wrist can bend in both the palm side and back side of the hand.

According to the wrist assisting device of the embodiment, as shown in FIG. 15, the axis A that connects a fulcrum 131B of the forearm attachment 130 of the non-driven side artificial muscle 150B of the two artificial muscles 150A and 150B and a turning fulcrum 121B of the second link member 160B of the angle changing member 120 does not pass through inside of the arc B formed by the axis of the coil spring. Therefore, the wrist can smoothly bend from the palm side to the back side or from back side to the palm side.

The one end of the artificial muscle 150A is a fulcrum 131A of the forearm attachment 130, and the other end of the artificial muscle 150A is a turning fulcrum 121A of the second link member 160B on the side of the angle changing member 120. That is, the axis of the two artificial muscles 150A and 150B that is of the non-driven side and connects fulcrums of the forearm attachment 130 and the angle changing member 120 may not pass through the inside of the arc formed by the axis of the coil spring. According to this configuration, the wrist can bend from the palm side to the back side or from the back side to the palm side.

The connection member 121 constitutes the angle changing member 120. Although the connection member 121 and the angle changing member 120 are different members in this embodiment, the connection member 121 may integrally formed with the angle changing member 120.

The wrist assisting device of the embodiment has the moving mechanism 111 that moves the palm placing member 110 that is the palm supporting member toward and away from the forearm. Therefore, it is possible to eliminate such uncomfortable feeling that a hand is pushed toward the forearm or pulled in a direction separating away from the forearm.

In the actual motion of a human body, if a wrist bends in a state where a palm is oriented upward, the wrist inclines inward (toward the human body) with respect to an axis of a forearm, and the wrist bends toward the palm or backward. To obtain motion close to the actual wrist bending motion, it is preferable that the wrist assisting device of the previous embodiments is mounted on the forearm. That is, it is preferable that metacarpus related members including the artificial muscle, the spring joint, the angle changing member and the palm placing member are mounted on the forearm in a state where these members are slightly twisted inward (toward the human body) with respect to the axis of the forearm.

Next, another embodiment of the muscle force assisting device of the present invention will be described.

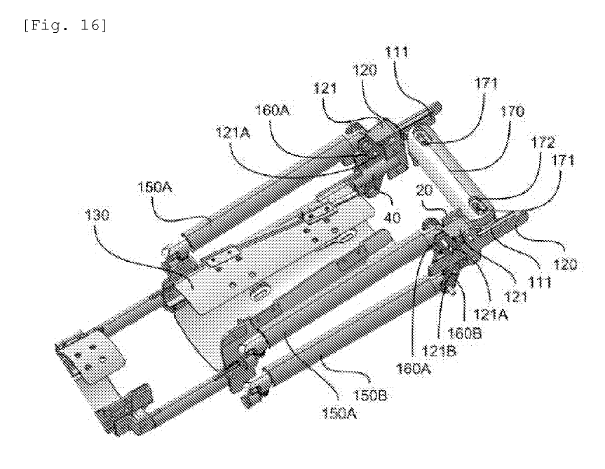

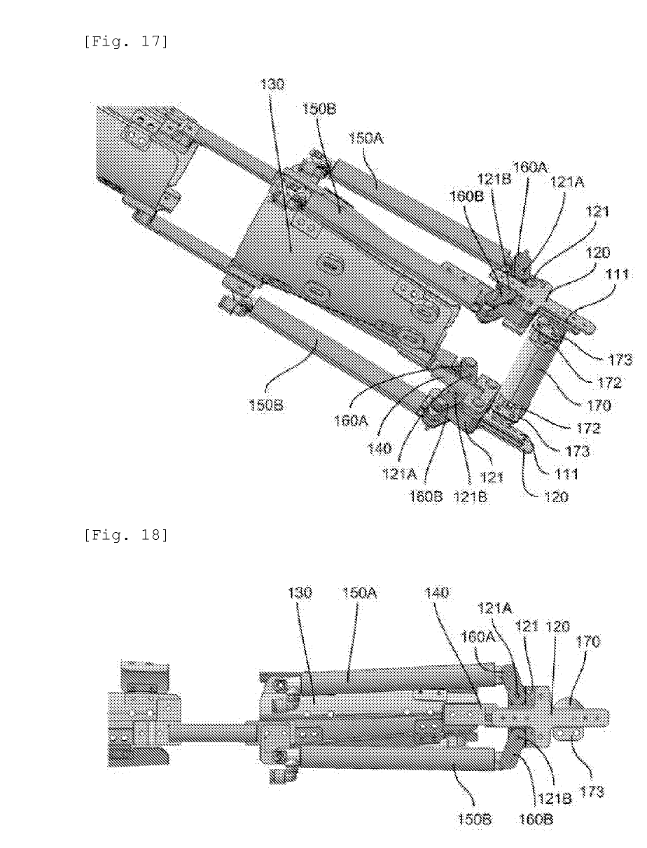

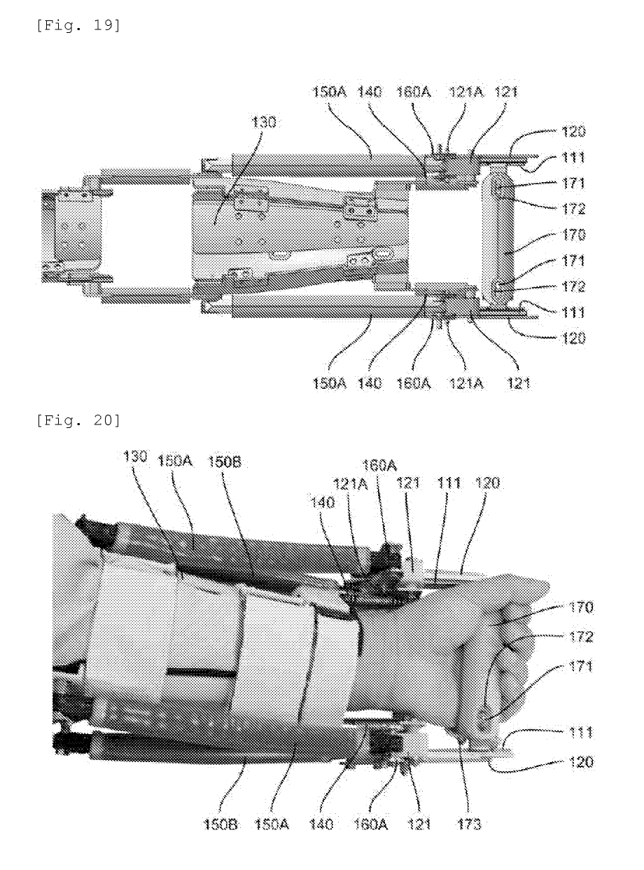

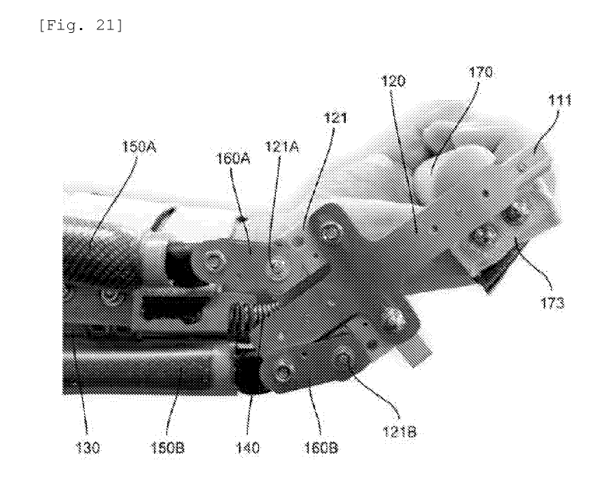

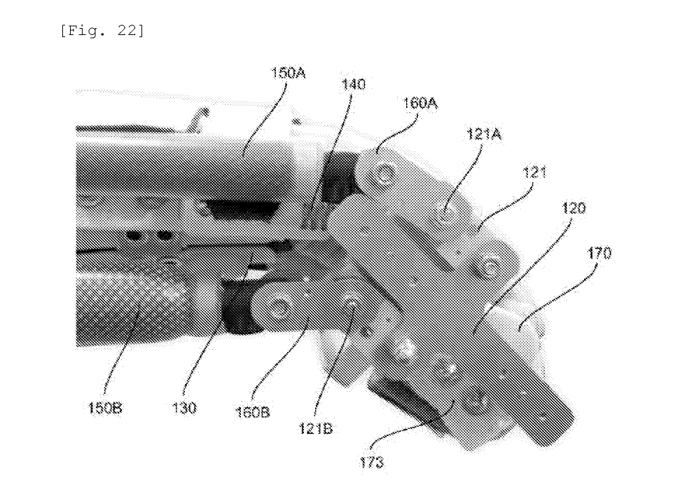

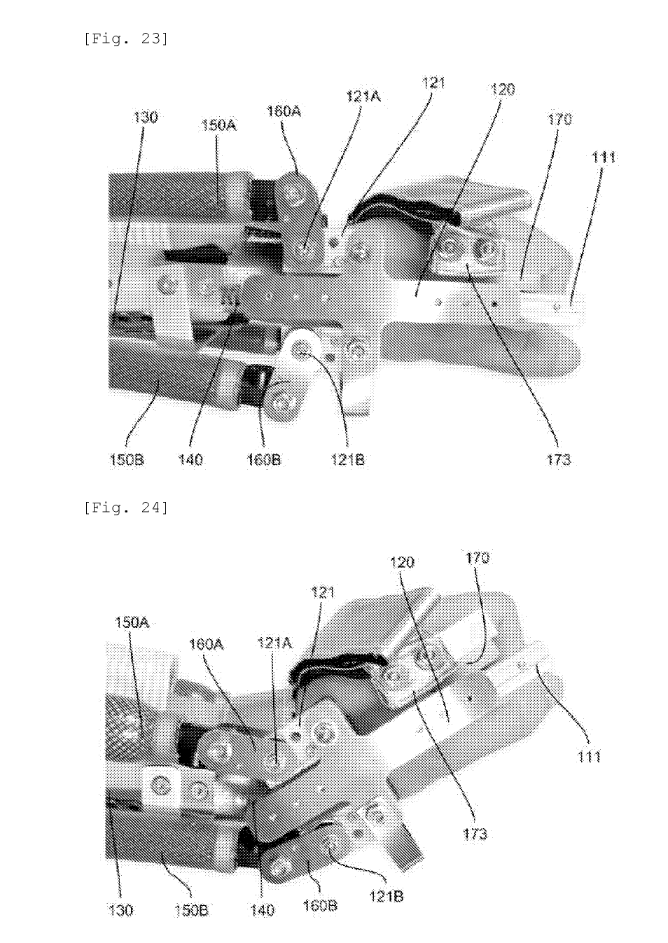

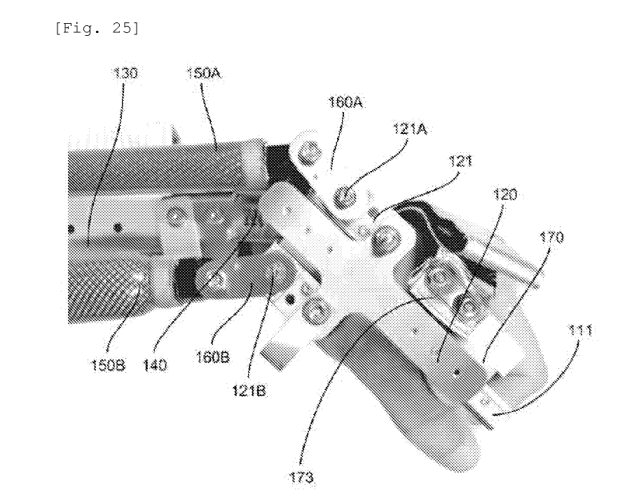

FIG. 16 is a perspective view of a wrist assisting device according to the other embodiment as viewed from above. FIG. 17 is a perspective view of the device as viewed from below. FIG. 18 is a side view of the device. FIG. 19 is a plan view of the device. FIG. 20 is a plan view showing a first using state of the device. FIG. 21 is a side view showing palm-bending state in the first using state of the device. FIG. 22 is a side view showing a back-bending state in the first using state of the device. FIG. 23 is a side view showing a second using state of the device. FIG. 24 is a side view showing a back-bending state in the second using state of the device. FIG. 25 is a side view showing a palm-bending state in the second using state of the device. The same members as those of the previous embodiments are designated with the same symbols, and explanation thereof will be omitted.

In the wrist assisting device of the embodiment, a connection member 121 is connected to the angle changing member 120, and one ends of the first link member 160A and the second link member 160B are turnably mounted on the connection member 121.

That is, the wrist assisting device of the embodiment includes the first link member 160A that is provided a turning fulcrum that is the palm side position 121A of the connection member 121 connected to the angle changing member 120, and the second link member 160B that is provided a turning fulcrum that is the back side position 121B of a hand of the connection member 121 connected to the angle changing member 120. The artificial muscle 150A is turnably connected to the other end of the first link member 160A, and the artificial muscle 150B is turnably connected to the other end of the second link member 160B.

The palm side position 121A that is the turning fulcrum of the first link member 160A, and the back side position 121B of a hand that is the turning fulcrum of the second link member 160B are disposed closer to the forearm attachment 130 than a mounting position of the coil spring of the angle changing member 120. A position in the vicinity of substantially center of the axis of the coil spring that is the joint member 140 in its longitudinal direction is a joint position of the wrist.

This embodiment includes a palm grasping member (palm supporting member) 170 that supports the palm side instead of the palm placing member 110 of the previous embodiments. Moving mechanisms 111 that moves the palm grasping member 170 toward and away from the forearm are provided on both ends of the palm grasping member 170. The palm grasping member 170 and the moving mechanisms 111 are connected to each other through turning shafts 171. The turning shafts 171 are provided in long holes 172 so that an angle of the palm grasping member 170 can be changed with respect to the moving mechanism 111.

Belt-fixing tools 173 on which a belt is mounted are provided on both ends of a lower surface of the palm grasping member 170. The long hole 172 is one example of a configuration that makes it possible to displace the turning shaft 171 with respect to the palm grasping member 170.

That is, the wrist assisting device of the embodiment includes the moving mechanisms 111 that moves the palm grasping member 170 toward and away from the forearm, and turning shafts 171 that change an angle with respect to the moving mechanism 111 are provided on both ends of the palm grasping member 170, and the turning shafts 171 can be displaced with respect to the palm grasping member 170. Since it is possible to change the angle of the palm grasping member 170, it is easy to grasp the palm grasping member 170. Especially when a wrist is crooked due to injury, the wrist assisting device can be used without undue stress.

FIGS. 20 to 22 show a first using state of the wrist assisting device of the embodiment. FIG. 21 shows a palm-bending state, and FIG. 22 shows a back-bending state. In the first using state, a palm is oriented upward and grasps the palm grasping member 170.

FIGS. 23 to 25 show a second using state of the wrist assisting device of the embodiment. FIG. 24 shows a back-bending state, and FIG. 25 shows a palm-bending state. According to the wrist assisting device of the embodiment, in the second using state, the palm can be oriented downward and can grasp and use the palm grasping member 170.

The angle of the palm grasping member 170 can be changed in accordance with a state of a user's wrist, and a position of the palm grasping member 170 can also adjusted in accordance with a size of a user's hand.

That is, as shown in FIGS. 20 to 25, the wrist assisting device of the embodiment includes the moving mechanisms 111 on the palm grasping member 170. According to the embodiment, by the moving mechanisms 111 that move the palm grasping member 170 toward or away from the forearm, it is possible to eliminate such uncomfortable feeling that a hand is pushed toward the forearm or pulled in a direction separating away from the forearm.

Especially, as shown in FIGS. 22 and 24, in the wrist assisting device of the embodiment, the palm supporting member is the palm grasping member 170 that supports the palm side. According to the embodiment, when the palm grasping member 170 is used as the wrist assisting device, as compared with a case where the palm placing member 110 in the previous embodiment is used, play between the wrist assisting device and a hand is reduced, and a sufficient back-bending region can be secured.

According to the second using state, even if an axis of the coil spring and a position of a wrist joint of a user are deviated from each other, both the back-bending motion and palm-bending motion can be carried out appropriately.

In this embodiment, the belt-fixing tools 173 are provided on the lower surface of the palm grasping member 170, but the palm placing member 110 may be provided instead of the belt-fixing tools 173. By fixing the grip of the palm placing member 110 in addition to the belt or palm attachment, sufficient rehabilitation effect can be obtained even if grasping power is weakened.

Although the upper surface of the forearm attachment 130 is opened in this embodiment, the lower surface of the forearm attachment 130 may be opened.

When the palm side of the forearm attachment 130 is opened, since the forearm attachment 130 is located on the back side of the forearm, play at the time of back-bending motion can be reduced. When the back side of the forearm attachment 130 is opened, it is easy to wear the device, and a natural using feeling can be obtained. If the palm grasping member 170 is detachably attached, the palm grasping member 170 can be mounted on the angle changing member 120 from both upper and lower sides, and a wrist assisting device having flexible wearing posture can be realized.

That is, according to the wrist assisting device of the embodiment, the belt-fixing tool is provided on the upper or lower surface of the palm grasping member. Therefore, the device can be supported by a belt even if grasping power is weakened.

According to the wrist assisting device of the embodiment, the palm placing member is provided on the upper or lower surface of the palm grasping member. Therefore, the device can be supported from the back side of the hand even if grasping power is weakened.

As described above, the wrist assisting device of the embodiment includes the palm grasping member (palm supporting member) 170 that supports a hand, the angle changing members 120 connected to the sides of the palm grasping member 170, the forearm attachment 130 disposed along a forearm, and the joint members 140 that displace the angle changing members 120 with respect to the forearm attachment 130, the palm grasping member 170 and the angle changing member 120 constitute the first attachment, and the forearm attachment 130 constitutes the second attachment. The first attachment and the second attachment are connected to each other through the joint members 140, and coil springs constitute the joint members 140. With this configuration, even if the wrist assisting device and a joint are deviated from each other in position, the coil springs are deformed, the deviation is moderated, and smooth motion can be secured.

According to the wrist assisting device of the embodiment, the angle changing members 120 are provided on both sides of the palm placing member 110, the joint members 140 are provided on the angle changing members 120, respectively, and the joint members 140 are disposed on both sides of the wrist. With this, since the wrist is supported from both sides, the wrist can smoothly move, and the wrist can be held strongly.

According to the wrist assisting device of the embodiment, the coil springs that are the joint members 140 are used as the extension springs. With this, a resistance caused at the time of the palm-bending or back-bending motion of a wrist joint is reduced, and smooth motion can be carried out.

According to the wrist assisting device of the embodiment, the coil springs that are the joint members 140 are used as compression springs. Therefore, the length of the spring becomes constant at the axis of the spring with respect to the palm-bending or back-bending motion of the wrist. Therefore, by disposing the axis on an axis of the wrist joint, influence of deviation can be suppressed to a low level in any of bending direction. Thus, smooth motion can be carried out. Since there is no contact between the coils, degeneration or alteration caused by a rub between the coils can be suppressed even if the device is repeatedly used for a long term.

In the embodiment, the forearm attachment 130 and the angle changing members 120 are connected to each other through the artificial muscle 150, and the actuator that is extensible by supplying or discharging a substance such as gas, liquid and solid, or a mixture thereof is used as the artificial muscle 150. With this, motion that is close to a muscle of a human body can be realized, and rehabilitation effect is enhanced.

In the embodiment, the first link member 160A that is provided a turning fulcrum that is the palm side position 120A of the angle changing member 120, and the second link member 160B that is provided a turning fulcrum that is the back side position 120B of a hand of the angle changing member 120 are provided, the artificial muscles 150 are respectively connected to the other end of the first link member 160A and the other end of the second link member 160B. With this, the wrist can smoothly bend toward the palm side and the back side of the hand.

Since the mechanism members that are required for bending and stretching motion of the wrist are disposed only the side surface of the wrist on the back side or palm side of the hand in the embodiment, the wearing feeling can be enhanced.

The present invention can be utilized as a muscle force assisting device that assists motion of a joint such as an elbow, a knee and a wrist.

What is claimed is:

1. A muscle force assisting device comprising
a first attachment arranged along one bone of a joint, and
a second attachment arranged along the other bone of the joint, in which
the muscle force assisting device assists motion of a user's joint such as an elbow, a knee and a wrist, wherein
the first attachment and the second attachment are connected to each other through a spring joint, and a coil spring is used as the spring joint.

2. The muscle force assisting device according to claim 1, further comprising an artificial muscle having one end provided on the first attachment and having the other end provided on the second attachment, wherein
an actuator that is extensible by supplying or discharging a substance such as gas, liquid and solid, or a mixture thereof is used as the artificial muscle.

3. The muscle force assisting device according to claim 1, wherein the coil spring is used as an extension spring.

4. The muscle force assisting device according to claim 1, wherein when a phantom line passing through a turning axis of the joint and extending along a longitudinal direction of the first attachment is defined as an X-axis, and a phantom line passing through the turning axis of the joint and extending perpendicular to the X-axis is defined as a Y-axis, and when a bending direction of the second attachment with respect to an intersection between the X-axis and the Y-axis is defined as a plus direction of the Y-axis, in a state where the second attachment stretches with respect to the first attachment, an axis of the coil spring is located at a minus position of the Y-axis.

5. The muscle force assisting device according to claim 2, wherein the one end of the artificial muscle can be displaced with respect to the first attachment, the one end of the artificial muscle is displaced, thereby increasing a bending angle of the second attachment with respect to the first attachment as compared with a case where the one end of the artificial muscle is not displaced.

6. The muscle force assisting device according to claim 5, wherein
the first attachment includes a swing arm,
an end of the swing arm on a side opposite from the joint is a turning fulcrum, and an end of the swing arm on a side of the joint is a displacing end, and
the one end of the artificial muscle is provided on the displacing end of the swing arm.

7. The muscle force assisting device according to claim 1, further comprising a palm supporting member that supports a hand,
an angle changing member connected to a side of the palm supporting member,
a forearm attachment arranged along a forearm, and
a joint member that displaces the angle changing member with respect to the forearm attachment, wherein
the palm supporting member and the angle changing member constitute the first attachment, and
the forearm attachment constitutes the second attachment.

8. The muscle force assisting device according to claim 7, wherein the palm supporting member is a palm placing member that supports a back side of a hand.

9. The muscle force assisting device according to claim 7, wherein the palm supporting member is a palm grasping member that supports a palm side.

10. The muscle force assisting device according to claim 7, further comprising one more angle changing member, wherein the angle changing members are provided on both sides of the palm supporting member, the angle changing members have coil springs, respectively, and the coil springs are disposed on both sides of the wrist.

11. The muscle force assisting device according to claim 10, wherein the coil springs are used as extension springs.

12. The muscle force assisting device according to claim 10, wherein the coil springs are used as compression springs.

13. The muscle force assisting device according to claim 7, wherein the forearm attachment and the angle changing member are connected to each other through a straight driving actuator.

14. The muscle force assisting device according to claim 13, wherein an artificial muscle that is extensible by supplying or discharging a substance such as gas, liquid and solid, or a mixture thereof is used as the actuator.

15. The muscle force assisting device according to claim 10, wherein the forearm attachment and the angle changing member are connected to each other using two artificial muscles with respect to each angle changing member, and an actuator that is extensible by supplying or discharging a substance such as gas, liquid and solid, or a mixture thereof is used as the artificial muscle.

16. The muscle force assisting device according to claim 15, wherein an axis that connects fulcrums of the forearm attachment and the angle changing member on a non-driven artificial muscle of the two artificial muscles does not pass through inside of an arc formed by an axis of the coil spring.

17. The muscle force assisting device according to claim 15, further comprising a first link member that is provided a turning fulcrum that is a palm side position of the angle changing member, and a second link member that is provided a turning fulcrum that is a back side position of the hand of the angle changing member, wherein the artificial muscles are connected to the other end of the first link member and the other end of the second link member, respectively.

18. The muscle force assisting device according to claim 17, wherein an axis that connects a fulcrum on the side of the forearm attachment and a turning fulcrum of the link member on the side of the angle changing member on a non-driven artificial muscle of the two artificial muscles does not pass through inside of an arc formed by an axis of the coil spring.

19. The muscle force assisting device according to claim 17, wherein the turning fulcrum of the first link member and the turning fulcrum of the second link member are disposed on a side closer to the forearm attachment than a position of the angle changing member where the coil spring is mounted, and a position in the vicinity of substantially a center of the coil spring in its longitudinal direction of its axis is a joint position of the wrist.

20. The muscle force assisting device according to claim 7, further comprising a moving mechanism that moves the palm supporting member toward or away from the forearm.

21. The muscle force assisting device according to claim 8, wherein a palm attachment is provided on an upper surface of the palm placing member, and a moving mechanism that moves the palm attachment toward or away from the forearm is provided.

22. The muscle force assisting device according to claim 9, wherein moving mechanisms that move the palm grasping member toward or away from the forearm, and turning axes that change an angle with respect to the moving mechanisms are provided on both ends of the palm grasping member, and the turning axes can be displaced with respect to the palm grasping member.

23. The muscle force assisting device according to claim 9, wherein a belt-fixing tool is provided on an upper surface or a lower surface of the palm grasping member.

24. The muscle force assisting device according to claim 9, wherein a palm placing member is provided on an upper surface or a lower surface of the palm grasping member.
